(19) United States
(12) Patent Application Publication
(10) Pub. No.: US 2019/0084061 A1
(43) Pub. Date: Mar. 21, 2019

(54) METHOD FOR CUTTING A MATTRESS, A PANEL, OR A SLAB OF MINERAL WOOL OR A POROUS CONSTRUCTION MATERIAL

(71) Applicant: SAINT-GOBAIN PLACO, Suresnes (FR)

(72) Inventor: Jean-Pierre DOUCHE, Le Plessis Brion (FR)

(73) Assignee: SAINT-GOBAIN PLACO, Suresnes (FR)

(21) Appl. No.: 16/082,418

(22) PCT Filed: Mar. 15, 2017
(86) PCT No.: PCT/FR2017/050593

§ 371 Date: Sep. 5, 2018

(30) Foreign Application Priority Data
Mar. 15, 2016 (FR) 1652198
Mar. 15, 2016 (FR) 1652199

(51) Int. Cl. B23D 57/00; B23D 61/18

(52) U.S. Cl. CPC B23D 57/0007; B23D 57/0046; B23D 61/185; B23D 57/0061; B23D 57/0069; B23D 57/0053

(57) ABSTRACT

A method for cutting a starting panel of mineral wool or porous construction material into several panels includes supplying a starting panel having a front edge and cutting the panel into two in its thickness by a wire by moving the panel in a direction (X). The wire passes in a direction (Y) perpendicular to the direction (X) to form two first panels. The method also includes cutting the rear edge of the two first panels and the front edge of two second panels by moving the wire in a direction (Z) perpendicular both to the direction (X) and to the direction (Y), cutting the panel into two in its thickness using the wire by moving the panel in the direction (X) to form the two second panels, and repeating the cutting front/rear edges and cutting in the thickness to form two third, fourth, etc. panels.

The invention relates to a method for cutting a mat or panel made of mineral wool. It applies quite particularly to acoustic insulation products based on mineral wool.

Mats or panels made of mineral wool are made up of mineral fibers manufactured by internal or external centrifugal spinning from molten inorganic material. Binder is sprayed onto the mineral fibers before they land on a receiving belt. The mats or panels are obtained after passage through an oven to polymerize the binder. There are also binderless products which are consolidated through a mechanical process known as needling. The mats or panels may be made of glass wool, rock wool, or even slag wool.

The mineral wool mats or panels obtained after centrifugal spinning sometimes need to be cut in their length or their width in order to reduce their size, to be cut in their thickness in order to produce a thinner mat and/or to be cut on their edges in order to form rabbets or any other edge detail. It is known practice to make these various cuts using a bandsaw, a circular saw and/or a router. However, these cutting devices produce cuts of mediocre quality which may sometimes require a rework operation after cutting, for example hiding with paint, or sanding. These cutting devices also have the disadvantage of generating a great deal of dust, which is potentially hazardous to the operators. Finally, saw-cutting devices generally have sawteeth which are offset in the thickness on each side of the saw blade, something which may generate a cut that is wider than necessary, causing a significant amount of waste, and spoilage of the material.

This problem more particularly arises when the mineral wool product is made of rock wool, which is a portion of relatively high density (typically higher than 25 kg/m³), because of the significant proportion of what are known as “unfiberized” particles which, as the saw blade passes, cause material to be torn out: not only the particle of mineral material itself, but also a bundle of fibers which are attached to this particle by the polymerized binder.

The invention also relates to a device and to a method for cutting a plate or panel of porous construction material. This plate or panel may be made of any porous construction material, for example based on fibers such as mineral wool or wool from biologically sourced materials, or a wool made up of different types of fibers. The panel may also be a pressed mineral fiber panel or alternatively a panel based on biologically sourced materials, such as wood or other natural fibers, or based on polymer fibers, or based on a mixture of different types of fibers, etc.

These porous construction materials may be produced by on-line processes in which a mixture is prepared via a dry route or a liquid route, in particular as an airborne suspension of fibers, this mixture containing a binding agent, and the mixture is deposited or spread on a conveyor member and subjected to operations of setting or curing the binding agent. Finally, a solid material is obtained which is cut to the desired dimensions to fashion an end-finished product, where appropriate prior to later transformation steps. A first cut is made on-line in order to separate individual elements, and one or more cutting operations may be performed as rework operations in shaping workshops.

There are, in the on-line methods, cutting devices such as guillotine saws, bandsaws, circular saws, or even milling cutters or routers. However, these cutting devices also have the disadvantage of generating a great deal of dust, which is potentially hazardous to the operators. In addition, these cutting devices generally have sawteeth which are offset in the thickness, something which may generate significant amounts of waste and spoilage of the material.

There are also high-pressure waterjet devices which, although they admittedly limit the amount of dust, have the disadvantage of supplying a significant quantity of water to the cutting surfaces, which water may be absorbed by the porous material and compromise the properties, including the mechanical properties, of the material at the expense the quality of the final build.

There is therefore a need for a device for cutting mats or panels made of mineral wool that allows a clean cut to be produced without subsequent sanding, and which greatly limits the waste and dust generated, or even for a device for cutting plates or panels, which allows a cut to be made in a porous construction material that greatly limits the waste and dust generated.

For that, the invention proposes a device for cutting a mat or panel of mineral wool, comprising:
movement means that move the mineral wool mat or panel and comprise at least one conveyor, and which are able to move in a direction,
a diamond-gritted wire intended to cut the mineral wool mat or panel,
means of passing the diamond-gritted wire in a direction perpendicular to the direction of travel of the mineral wool mat or panel.

According to another particular feature, the diamond-gritted wire is a steel wire comprising abrasive particles, in particular of zirconium oxide, at its surface, the diamond-gritted wire having a diameter of between 400 μm and 700 μm, with abrasive particles of a size preferably comprised between 30 and 80 μm.

According to another particular feature, the diamond-gritted wire is fixed at each of its ends to a reel, the diamond-gritted wire being wound on the two reels, which are slaved to one another, the space between the two reels being greater than at least one dimension of the mineral wool mat or panel that is to be cut.

According to another particular feature, the linear speed at which the diamond-gritted wire passes is comprised between 10 m/s and 20 m/s.

According to another particular feature, the tension in the diamond-gritted wire is comprised between 150 N and 500 N.

According to another particular feature, the device further comprises holding means that hold the mineral wool mat or panel, the holding means comprising a suction holding system designed to move simultaneously with and in the same direction as the movement means that move the mineral wool mat or panel.

According to another particular feature, the device further comprises movement means that move the diamond-gritted wire, the diamond-gritted wire being able to move in a direction perpendicular both to the direction of travel of the mineral wool mat or panel and to the direction in which the diamond-gritted wire passes.

According to another particular feature, the speed of travel of the mineral wool mat or panel is between 500 mm/s and 2 m/s for cutting in the thickness and between 10 mm/s and 250 mm/s for cutting on the edges.

According to another particular feature, the speed of travel of the diamond-gritted wire is between 10 mm/s and 250 mm/s.

The invention also proposes a method for cutting a mineral wool mat or panel, comprising the following steps:
supply of a mineral wool mat or panel,
movement of the mineral wool mat or panel in a direction by movement means that move the mineral wool mat or panel and comprise at least one conveyor,
cutting of the mineral wool mat or panel by a diamond-gritted wire able to pass in a direction perpendicular to the direction of travel of the mineral wool mat or panel.

According to another particular feature, the cut is made by a steel wire comprising abrasive particles, in particular of zirconium oxide, at its surface, the diamond-gritted wire having a diameter of between 400 μm and 700 μm with abrasive particles of a size preferably comprised between 30 and 80 μm.

According to another particular feature, the diamond-gritted wire is wound onto and unwound from two reels slaved to one another, the space between the two reels being greater than the dimensions of the mineral wool mat or panel that is to be cut.

According to another particular feature, the diamond-gritted wire passes at a linear speed of between 10 m/s and 20 m/s.

According to another particular feature, the tension in the diamond-gritted wire is set to a value of between 150 N and 500 N.

According to another particular feature, the mineral wool mat or panel moves at a speed of between 500 mm/s and 2 m/s for cutting in the thickness and between 10 mm/s and 250 mm/s for cutting on the edges.

According to another particular feature, the method further comprises a step in which holding means take hold of the mineral wool mat or panel, the holding means comprising a suction holding system designed to move simultaneously with and in the same direction as the movement means that move the mineral wool mat or panel.

According to another particular feature, during the step of cutting the mat, the diamond-gritted wire is able to move in a direction perpendicular both to the direction of travel of the mineral wool mat or panel and to the direction in which the diamond-gritted wire passes, so as to make a cut in two mutually perpendicular directions.

According to another particular feature, the diamond-gritted wire moves at a speed comprised between 10 mm/s and 250 mm/s for cutting on the edges.

The invention also proposes a mineral wool panel cut by the cutting device according to the invention, according to the method of the invention, and comprising, on at least one of its main faces or one of its edges, an excellent-quality cut that is smooth to within a few tenths of a millimeter.

The invention also proposes a device for cutting a plate or panel of porous construction material, comprising:
movement means that move the plate or panel and comprise at least one conveyor, and which are able to move in a direction,
a wire designed to cut the plate or panel,
means causing the wire to pass in a direction perpendicular to the direction of travel of the plate or panel.

According to another particular feature, the wire is a steel wire of a diameter comprised between 300 μm and 2 mm, particularly between 400 μm and under 1 mm, in particular between 400 μm and 700 μm.

According to another particular feature, the wire comprises at its surface abrasive particles of a size preferably comprised between 30 and 80 μm.

According to another particular feature, the abrasive particles are, in particular, particles of diamond or of zirconium oxide or of boron nitride.

According to another particular feature, the wire is fixed at each of its ends to a reel, the wire being wound on the two reels, which are slaved to one another, the space between the two reels being greater than at least one dimension of the plate or panel that is to be cut.

According to another particular feature, the linear speed at which the wire passes is comprised between 10 m/s and 20 m/s.

According to another particular feature, the tension in the wire is comprised between 150 N and 500 N.

According to another particular feature, the device further comprises holding means that hold the plate or panel, the holding means comprising a suction holding system designed to move simultaneously with and in the same direction as the movement means that move the plate or panel.

According to another particular feature, the device further comprises movement means that move the wire, the wire being able to move both in a direction perpendicular to the direction of travel of the plate or panel and to the direction in which the wire passes.

According to another particular feature, the speed of travel of the plate or panel is between 10 mm/s and 2 m/s, particularly between 500 mm/s and 2 m/s for cutting in the thickness or between 10 mm/s and 2 m/s, in particular between 10 mm/s and 250 mm/s for cutting on the edges.

According to another particular feature, the speed of travel of the wire is between 10 mm/s and 2 m/s, in particular between 10 mm/s and 250 mm/s for cutting on the edges.

According to another particular feature, with the device being installed on the production line that produces the plate or panel of construction material, the speed of travel of the plate or of the panel is at least 1 m/min, preferably at least 2 m/min, it being possible for the cut to be made in the thickness or on the edges.

The invention also relates to a method for cutting plates or panels of porous construction material, comprising the following steps:
supply of a plate or panel of porous construction material,
movement of the plate or panel in a direction by movement means that comprise at least one conveyor,
cutting of the plate or panel by a wire able to pass in a direction perpendicular to the direction of travel of the plate or panel.

According to another particular feature, the cut is made by a steel wire with a diameter of between 300 μm and 2 mm, particularly between 400 μm and under 1 mm, in particular between 400 μm and 700 μm.

According to another particular feature, the wire at its surface comprises abrasive particles, of a size preferably comprised between 30 and 80 μm.

According to another particular feature, the abrasive particles are made of diamond or zirconium oxide or boron nitride.

According to another particular feature, the wire is wound onto and unwound from two reels which are slaved to one another, the space between the two reels being greater than the dimensions of the plate or of the panel that is to be cut.

According to another particular feature, the wire passes at a linear speed of between 10 m/s and 20 m/s.

According to another particular feature, the tension in the wire is set to a value of between 150 N and 500 N.

According to another particular feature, the plate or panel moves at a speed of between 10 mm/s and 2 m/s, in particular between 500 mm/s and 2 m/s for cutting in the thickness or between 10 mm/s and 2 m/s, in particular between 10 mm/s and 250 mm/s for cutting on the edges.

According to another particular feature, the method further comprises a step in which holding means take hold of the plate or panel, the holding means comprising a suction holding system designed to move simultaneously with and in the same direction as the movement means that move the plate or panel.

According to another particular feature, during the step of cutting the plate or panel, the wire is able to move in a direction perpendicular both to the direction of travel of the plate or panel and to the direction in which the wire passes, so as to make a cut in two mutually perpendicular directions.

According to another particular feature, the wire moves at a speed of between 10 mm/s and 2 m/s, in particular between 10 mm/s and 250 mm/s for cutting on the edges.

According to another particular feature, the cutting step is performed on the production line that produces the plate or panel of construction material, in which the speed of travel of the plate or panel is at least 1 m/min, preferably at least 2 m/min, it being possible for cutting to be performed in the thickness or on the edges.

The invention also relates to a method for cutting a starting mat, panel or plate of mineral wool or porous construction material into several mats, panels or plates, comprising the following steps:
supplying a starting mat, panel or plate of mineral wool or porous construction material, the starting mat, panel or plate having a front edge,
cutting the starting mat, panel or plate into two in its thickness by means of a wire, by moving the mat, panel or plate in a direction using movement means that move the mat, panel or plate and comprise at least one conveyor, the wire being able to pass in a direction perpendicular to the direction of travel of the mat, panel or plate, so as to form two first mats, panels or plates,
cutting the rear edge of the two first mats, panels or plates and the front edge of two second mats, panels or plates by moving the wire in at least a direction perpendicular both to the direction of travel of the mat, panel or plate and to the direction in which the wire passes,
cutting the mat, panel or plate into two in its thickness using the wire, by moving the mat, panel or plate in the direction of travel of the mat, panel or plate so as to form the two second mats, panels or plates,
repeating the steps of cutting front/rear edges and of cutting in the thickness in order to form two third, fourth, etc. mats, panels or plates.

According to another particular feature, the method of cutting further comprises a step of cutting a rabbet in the front edge of the starting mat, panel or plate, a rabbet in the rear edge of the two first mats, panels or plates, a rabbet in the front edge of the two second mats, panels or plates, and so on so as to form rabbets in the rear and front edge of, respectively, the two second and third mats, panels or plates, the two third and fourth mats, panels or plates, etc., by moving the wire in the direction and the mat, panel or plate in the direction so as to make a cut in two mutually perpendicular directions, it being possible for these two movements to be simultaneous.

According to another particular feature, the method of cutting further comprises a step of rotating each first, second, etc. mat, panel or plate through 90°, then a step of cutting each first, second, etc. mat, panel or plate transversely in the direction of the initial length so as to cut rabbets on the two remaining edges.

According to another particular feature, the cutting is performed by a wire having a diameter of between 400 μm and 700 μm, or even between 300 μm and 700 μm, or even between 300 μm and under 1 mm, or even between 300 μm and 2 mm.

According to another particular feature, the wire is diamond-gritted and comprises abrasive particles, in particular of zirconium oxide, at its surface, of a size preferably comprised between 30 and 80 μm.

According to another particular feature, the wire passes at a linear speed of between 10 m/s and 20 m/s.

According to another particular feature, the tension in the wire is set to a value of between 150 N and 500 N.

According to another particular feature, the mat, panel or plate moves at a speed of between 500 mm/s and 2 m/s for cutting in the thickness, and between 10 mm/s and 250 mm/s for cutting on the edges.

According to another particular feature, the method of cutting further comprises a step in which holding means take hold of the mat, panel or plate, the holding means comprising a suction holding system designed to move simultaneously with and in the same direction as the movement means that move the mat, panel or plate.

Other features and advantages of the invention will now be described with reference to the drawings in which:

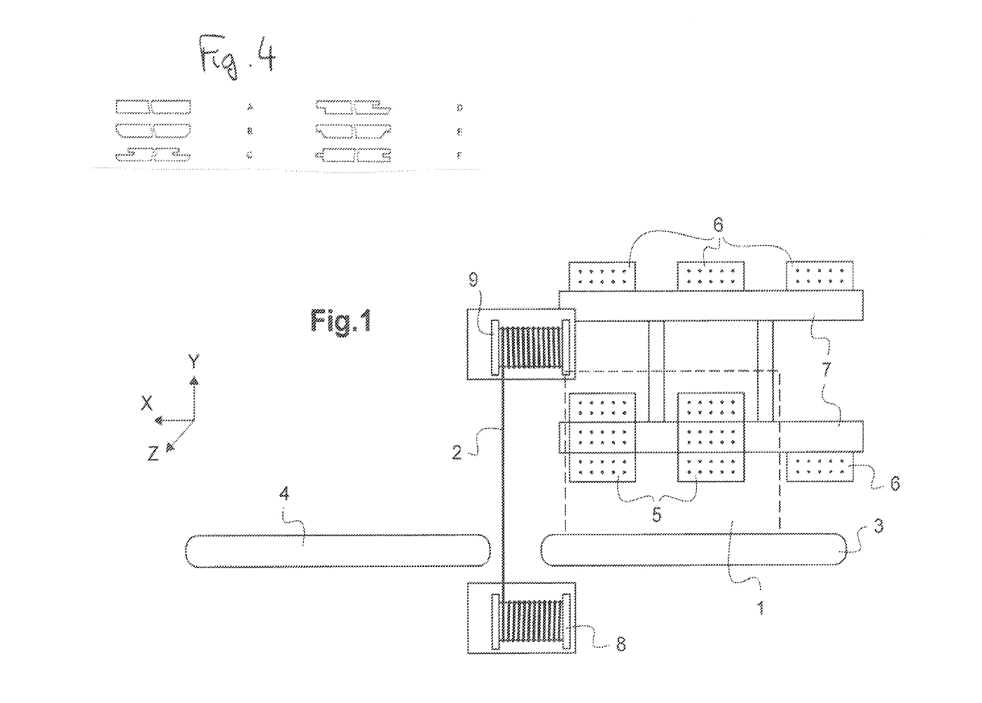

FIG. 1 depicts a face-on view of a cutting device according to the invention;

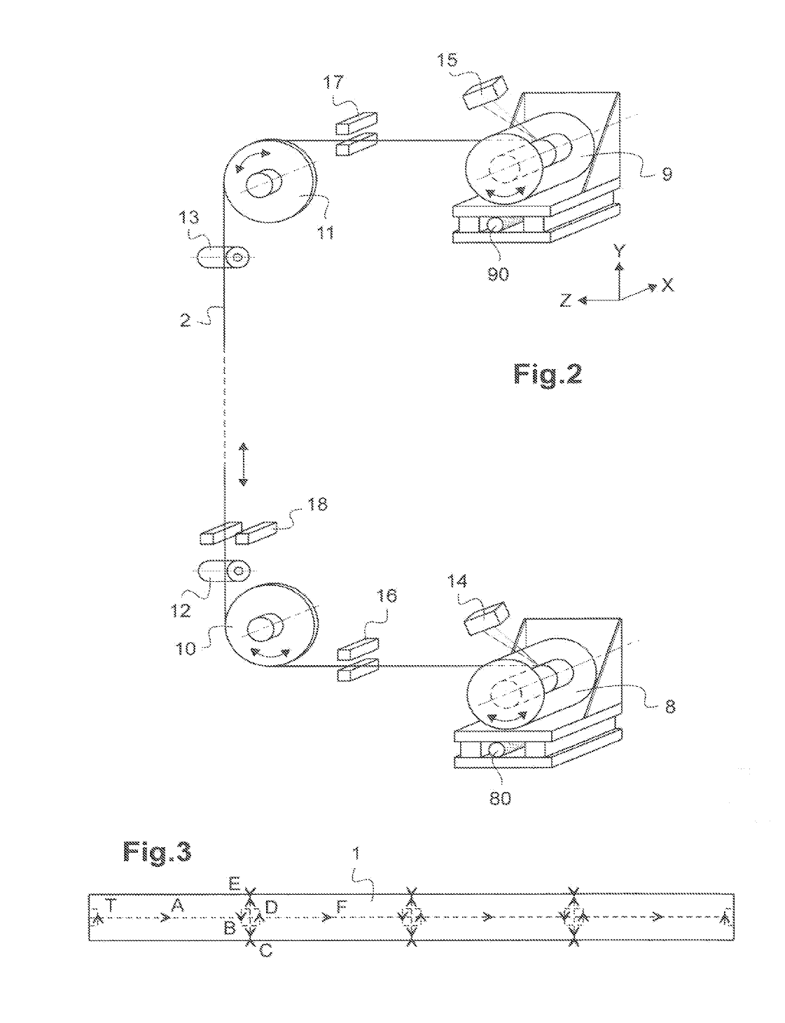

FIG. 2 depicts a detailed side view of the cutting device according to the invention;

FIG. 3 depicts a view in cross section of an example of cutting into a mat, panel or plate, performed with the device according to the invention; and

FIG. 4 depicts various types of mat, board or plate edges.

Reference numbers which are identical in the various figures represent elements that are similar or identical.

The invention relates to a device for cutting a mat or panel made of mineral wool, comprising movement means that move the mineral wool mat or panel and comprise at least one conveyor, and which are able to move in a direction X, a diamond-gritted wire designed to cut the mineral wool mat or panel, and means of passing the diamond-gritted wire in a direction Y perpendicular to the direction X of travel of the mineral wool mat or panel.

The wire allows material loss and waste generated to be limited as far as possible because a wire is far thinner than the saws of the known cutting devices. In addition, cutting using a wire generates practically no dust, making it possible to improve operator working conditions.

The diamond-gritted wire also allows an excellent-quality cut, with a clean surface finish, without the need to perform a later sanding operation; that makes it possible to limit material loss and waste generated as far as possible because the diamond-gritted wire is far thinner than the saws of the known cutting devices. In addition, cutting using a diamond gritted wire generates practically no dust, making it possible to improve operator working conditions.

Surprisingly, the use of a cutting wire under the conditions of the invention allows for an extremely clean cut. Particularly in the case of a rock wool product containing particles of unfiberized material, it has been found that the particulate cutting residue is considerably reduced in quantity and in mass, and that it contains far fewer particles than with conventional cutting, the particles in the main remaining included within the mineral product. It is assumed here that the cutting wire makes itself a path between the fibers, or respectively between the fibers and the particles, and frees the fibers by parting the entanglement of fibers rather than by breaking the fibers. This can be achieved by choosing a wire that is sufficiently thin in comparison with the defects of the fibrous product, typically of a diameter smaller than the size of the unfiberized particles which may measure from 1 to several millimeters in diameter.

In addition, the use of a diamond-gritted wire was not proposed in the prior art. Rather, the diamond-gritted wire had hitherto been intended for cutting hard and brittle materials, requiring a waterjet cooling system. The application by the inventors to the dry-cutting of fibrous materials, without a cooling water jet, has given rise to a novel usage giving access to fibrous products of a quality far superior to expectation.

According to the invention, what is meant by a “diamond-gritted wire” is a cutting wire, generally made of metal, bearing on its surface abrasive particles, such as of natural or synthetic diamond, advantageously based on zirconium oxide or on boron nitride. The particles are held on the surface of the core of the wire by brazing or by continuous deposition or metallic plating.

What is meant by a “mat or panel” is either a continuous strip, which generally corresponds to a mat as it leaves the oven, or a mat or panel of substantially parallelepipedal shape generally resulting from the Dn-line cutting after leaving the oven, and which may even have been cut again offline subsequently. The terms “mat or panel” include mats or panels designed to be rolled up for marketing purposes.

FIG. 1 depicts a face-on view of the cutting device according to the invention.

The mineral wool mat or panel 1 intended to be cut on the device according to the invention has, for example, a density greater than 25 kg/m³, preferably comprised between 30 kg/m³ and 180 kg/m³ to make cutting easier. The mineral wool mat or panel may for example be coated with a film on each of its main faces. Such a film may give the mat mechanical and acoustic properties.

The plate or panel 1 of porous construction material which is intended to be cut on the device according to the invention has, for example, a density greater than or equal to 5 kg/m³, particularly at least 10 kg/m³, in particular at least 20 to 25 kg/m³ and preferably less than 180 kg/m³.

The cutting device according to the invention comprises movement means that move a mat, panel or plate 1 of mineral wool or porous construction material in a direction X, as well as a wire 2 designed to cut the mat, panel or plate, it being possible for the wire to be diamond-gritted. The cutting device according to the invention also comprises means 8, 9 causing the wire 2 to pass in a direction Y perpendicular to the direction X of travel of the mineral wool mat or panel 1. Here, the means 8, 9 causing the wire to pass are reels. Alternatively, the wire may pass in the direction Y in a back-and-forth or reciprocating movement.

Depending on the embodiment, the wire 2 may also be fixed with respect to the direction Z or able to move in this direction Z, the direction Z being perpendicular both to the direction X of travel of the mineral wool mat or panel 1 and to the direction Y in which the wire 2 passes.

The movement means that move the mat, panel or plate 1 of mineral wool or porous construction material comprise at least one conveyor 3, 4. The conveyor 3, 4 is a horizontal belt conveyor on which the mat, panel or plate 1 rests. The conveyor may advance forward or move back according to the requirements of the cutting. The direction of travel is the axis X in FIG. 1. The mat, panel or plate 1 may rest horizontally, laid flat, or vertically, laid edge-on on the conveyor 3, 4.

The conveyor 3, 4 is preferably in two parts when the wire 2 is able to move in the direction Z. Thus, a space is left between the two conveyor parts 3, 4 to allow the wire 2 to pass for the transverse cutting of the mat, panel or plate 1 without being impeded by the conveyor.

When the mat, panel or plate 1 is in the form of a continuous horizontal strip, the wire 2 may allow on-line cutting, for example into two in the thickness. The wire 2 is then fixed and the mat rests horizontally on the conveyor.

When the mat, panel or plate 1 is in the form of a continuous horizontal strip, the wire 2 may also allow on-line transverse cutting, for example to form mats or panels of substantially parallelepipedal shape. The wire 2 is then able to move in the direction Z.

When the mat, panel or plate 1 rests vertically on the horizontal conveyor 3, 4, the wire 2 may be fixed with respect to the axis Z or able to move in the direction Z.

Depending on the embodiment, the cutting device according to the invention may therefore comprise means of moving the wire 2 in the direction Z, these movement means allowing the wire 2 to be moved in a direction Z perpendicular both to the direction X of travel of the mat, panel or plate 1 made of mineral wool or porous construction material and to the direction Y in which the wire 2 passes. Thus, the device allows cuts to be made in two mutually perpendicular directions. In that way, several different cuts can be made in a single pass. In addition, by combining the two movements in the directions X and Y, cuts of varying shapes may be made.

Moreover, when the mat or panel 1 rests vertically on the horizontal conveyor, the device comprises holding means 5, 6, 7 that hold the mat, panel or plate 1 so as to hold the mat, panel or plate in position. In such a case, the holding means 5, 6, 7 that hold the mat, panel or plate 1 are able to move simultaneously with and in the same direction X as the conveyor 3, 4 for a uniform movement of the mat, panel or plate 1.

The holding means that hold the mat, panel or plate 1 made of mineral wool or construction material comprise a suction holding system 5, 6, 7. The suction holding system 5, 6, 7 is made up of suction grippers 5, 6 fixed to a mobile support 7 designed to move at the same time as the conveyor or conveyors 3, 4 while the mat, panel or plate 1 is being cut. The suction grippers 5, 6 may take the form of plates pierced with a multitude of orifices which are connected to a depressurization means; the diameter of the orifices is chosen according to the force that is to be applied locally to the mat, panel or plate 1. The grippers 5, 6 may have different sizes, as depicted in FIG. 1. The mat, panel or plate 1 needs to be perfectly held by the suction grippers 5, 6 while the wire 2 is cutting so as to allow the cut to be as precise as possible. Larger-sized grippers 5 allow a firmer hold of small-sized mats, panels or plates. The suction grippers 5, 6 need to allow the mat, panel or plate 1 to be held without stressing or deforming it. These suction grippers react the load supplied by the wire as the mat, panel or plate 1 and/or the wire 2 move, so as to ensure perfect control over the dynamic positioning of the mat, panel or plate and so as to prevent any slippage of the mat, panel or plate with respect to the gripper. The various movements are synchronized through a numerical control system. In FIG. 1, only the suction grippers 5 are holding the mat, panel or plate 1, because in this exemplary embodiment, the mat, panel or plate is small in size. The peripheral suction grippers 6 are used to supplement the suction grippers 5 for mats, panels or plates 1 of larger size.

The wire 2 is preferably a steel wire of a diameter comprised between 300 μm and 2 mm, particularly between 400 μm and under 1 mm, in particular between 400 μm and 700 μm, preferably between 420 μm and 550 μm in order to improve the quality of the cut, or even between 480 μm and 520 μm in order to improve still further the quality of the cut. The steel wire may at its surface comprise abrasive particles which are, for example, made of diamond, of zirconium oxide or of boron nitride. It is then referred to as a diamond-gritted wire. The size of the abrasive particles is preferably comprised between 30 and 80 μm. The space between the abrasive particles is preferably comprised between 10 μm and 20 μm. The presence of abrasive particles makes it possible to achieve a clean cut, making it possible to dispense with the need for subsequent sanding. For cutting mineral wool, the wire 2 is preferably diamond-gritted.

According to one embodiment of the invention, the wire 2 is fixed at each of its ends to a reel 8, 9. The wire 2 is wound on the two reels 8, 9, the space between the two reels 8, 9 being greater than at least one dimension of the mat, panel or plate 1 that is to be cut. The wire 2 is preferably vertical (along the axis Y), as depicted in FIGS. 1 and 2. Each of the lower 8 and upper 9 reels is rotationally driven by a motor (not depicted). The reels 8, 9 are slaved to one another by a servo control system to make it possible to maintain a constant wire tension and to keep control over the speed at which the wire 2 passes. This servo control system is described in greater detail later on in the text. The wire 2 has a length of, for example, between 5 and 15 km. It is unwound from one reel to wind onto the other reel. When one reel 8, 9 is empty and the other is full, the direction in which the wire 2 passes is reversed so that the wire winds onto the empty reel and unwinds from the full reel.

FIG. 2 depicts a detailed side view of the cutting device according to the invention.

The wire 2 is guided, as it leaves each of the reels 8, 9, by a guide pulley 10, 11 respectively, which positions the wire 2 with respect to the mat, panel or plate 1 that is to be cut. On leaving each of the guide pulleys 10, 11, the wire is further guided by a respective roller 12, 13 which allows the wire to be positioned even more precisely still. Thus, when the wire 2 is in the vertical position (along the axis Y) as in FIGS. 1 and 2, the wire 2 passes for example over the lower reel 8, then over the lower guide pulley 10 then over the lower roller 12 then over the upper roller 13 then over the upper guide pulley 11 then onto the upper reel 9. When it is being cut by the wire 2, the mat, panel or plate 1 passes between the two rollers 12, 13.

The linear speed at which the wire 2 passes is comprised between 10 m/s and 20 m/s, preferably between 14 m/s and 16 m/s or is even equal to 15 m/s, to improve still further the quality of the cut. The wire 2 passes dry, without passing through a cooling liquid.

The tension in the wire 2 is comprised between 150 N and 500 N, preferably between 250 N and 350 N in order to improve still further the quality of the cut by reducing the bending of the wire. The tension in the wire is dependent on the diameter of the wire. The more taut the wire is, the more its bending is reduced. Because the wire 2 may be subjected to very high stresses, it is preferably made of high tensile steel capable of withstanding tensile stresses of as much as 1000 MPa, or even 2000 MPa.

The diameter, linear speed and tension of the wire 2 are three parameters that are very important to the clean cutting of the mat. Hence, the cutting device according to the invention comprises several sensors connected to the servo control system which allow the servo control system to adapt the rotational speed of the reels 8, 9 in real time (every 5 ms) in order to keep the linear speed and tension constant during cutting.

Thus, the cutting device comprises, facing each reel 8, 9, a respective optical sensor 14, 15 which measures the diameter of the reel (or, more precisely, the outside diameter of the winding of wire on the reel): as explained earlier, the diameter of the reel varies during cutting as the wire gradually unwinds from one reel to be wound onto the other reel. This variation in diameter is taken into consideration in real time to adjust the winding/unwinding speed of the reels 8, 9, and guarantee the desired linear speed. The data from these optical sensors 14, 15 also make it possible to evaluate how much length of wire remains on each of the reels.

The cutting device also comprises two position measuring sensors 16, 17 positioned respectively between the lower reel 8 and the lower guide pulley 10, and between the upper reel 9 and the upper guide pulley 11. These sensors 16 and 17 measure the position of the wire 2 along the axis X. Each of the reels 8, 9 is mounted on an endless screw 80, 90 respectively, the axis of which is parallel to the direction X, so as to allow real-time alignment between the position of the diamond-gritted wire 2 winding onto/unwinding from the reels 8, 9 and the position of the guide pulleys 10, 11 along the axis X. The sensors 16, 17 make it possible to regulate this reeling function.

The cutting device also comprises a bending-measurement sensor 18 positioned between the rollers 12, 13. This bending-measurement sensor 18 makes it possible to measure the deformation of the wire along the axis X, as imposed by the thrust applied by the product in its relative movement with respect to the wire. The data from this bending-measurement sensor 18, coupled with the data from the optical sensors 14, 15, make it possible to adjust the wire tension in real time by adjusting the speed of winding/unwinding of the reels 8, 9. This bending sensor 18 thus allows the straightness of the wire to be regulated.

The position and bending measurement sensors 16 to 18 are, for example, digital arrays provided with a plurality of laser beams which detect the path of the wire.

By virtue of these sensors 14 to 18 which are means of very precisely controlling the tension of the wire, the amplitude of vibration of the wire can thus be minimized so that no ripple can now be perceived through a visual inspection of the cut face, giving a near-perfect appearance. The wire tension, which is adjusted to avoid vibrations, means that the wire behaves more like a wedge driving a crack through the material than like a knife cutting the fibers in two.

Finally, the assembly formed by the wire 2, the reels 8, 9, the guide pulleys 10, 11, the rollers 12, 13 and the sensors 14 to 18 is mounted on a chassis or an upright (not depicted), itself associated with movement means (not depicted).

These movement means allow the wire 2 to be moved in the direction Z of FIG. 1, namely along an axis that is perpendicular both to the direction of travel of the mat, panel or plate 1 made of mineral wool or porous construction material, which is along the axis X, and to the direction Y in which the wire 2 passes. The two movements along the axes X and Z may be combined to make cuts of complex shape. The speed of travel of the wire 2 along the axis Z is comprised between 10 mm/s and 250 mm/s in order to allow precision in the geometric pattern at the edges.

The cutting device according to the invention allows a mat, panel or plate 1 of mineral wool or construction material to be cut:
in its width or its length in order to obtain a mat, panel or plate of smaller size,
in its thickness in order to obtain at least two mats, panels or plates of a thickness smaller than that of the starting mat or panel, and/or
on its edges so as to create a rabbet or any other form of edge detail.

During cutting, the speed at which the mat, panel or plate 1 of mineral wool or construction material travels is comprised between 500 mm/s and 2 m/s for cutting in the thickness, of the splitting type, and between 10 mm/s and 250 mm/s for cutting on the edges in order to allow precision in the geometric pattern of the edges. The mat, panel or plate 1 of mineral wool or construction material moves through the combined movement of the conveyors 3, 4 and of the suction holding system 5, 6, 7.

The edge cuts or rabbets may have any conceivable shapes, with geometries as varied as square, rectangular, triangular, polygonal, rounded, curved, sinusoidal, etc. FIG. 4 depicts various types of mat, panel or plate edges. These examples of edges come from standard EN 13964:2014 (F).

The movements of the mat, panel or plate, the movements of the wire, the winding/unwinding speeds of the reels, the movements of the endless screws and the actuation of the suction grippers are motorized and controlled by an overall control system of the device.

The cutting device according to the invention makes it possible for example to create mineral wool acoustic panels for ceilings. The rabbets made on each of the edges of such acoustic panels are intended to rest on a metal framework fixed to the ceiling. Such panels are generally square in shape but may also be rectangular. When the mat is cut into two in the thickness from a mat covered with a film on its two main faces, the resulting panel has a film on just one of its main faces. A film may therefore be bonded to the other main face of the panel resulting from the cut.

The cutting device according to the invention makes it possible for example to cut a mat, panel or plate at once in its thickness, transversely across its width, and on its edges to create rabbets or any other edge detail, as shown in FIG. 3 or 4 for example.

FIG. 3 depicts a view in cross section of one example of a cut in a mat, panel or plate 1, made using the device according to the invention, following a path defined by the succession of portions identified by the capital letters.

Thus, the mat, panel or plate 1 may be cut on one of its edges to create a rabbet (reference T), then into two in its thickness (reference A) then transversely across its width with simultaneous cutting of rabbets (references B, C, D, E), then cut into two again in the thickness (reference F) and so on so as to form several mats or panels with rabbets cut on two opposite edges. Each mat, panel or plate obtained is then rotated through 90° so as to make a transverse cut in the direction of the initial length with simultaneous cutting of rabbets on the two remaining edges. The rotation through 90° may be performed by means of a system of suction grippers similar to the grippers 5, 6, positioned facing the grippers 5, 6. As an alternative, the cut mats, panels or plates may be conveyed to another cutting station equipped with another wire designed to cut rabbets on the remaining edges.

It is also possible to cut the mat, panel or plate to the correct size first of all and then cut the rabbets.

This then yields one or more mats, panels or plates, for example square or rectangular ones, with rabbets on each of their edges and, as an option, a film on one of their main faces (if the initial mat, panel or plate is cut into two in the thickness and had a film on each of its main faces). Each mat, panel or plate of this type may subsequently be provided with a decorative film on its other main face.

The invention also relates to a method of cutting implementing the cutting device according to the invention.

Thus, the method for cutting a mineral wool mat comprises the following steps:
supply of a mineral wool mat or panel 1,
movement of the mineral wool mat or panel 1 in a direction X by movement means 3, 4 that move the mineral wool mat or panel 1 and comprise at least one conveyor,
cutting of the mineral wool mat by a diamond-gritted wire 2 able to pass in a direction Y perpendicular to the direction X of travel of the mineral wool mat or panel 1.

During cutting, the mineral wool mat or panel 1 is moved by virtue of the conveyor 3, 4. It may be held by virtue of the suction holding system 5, 6, 7. The diamond-gritted wire 2 may be able to move in a direction Z perpendicular both to the direction X of travel of the mineral wool mat or panel 1 and to the direction Y in which the diamond-gritted wire passes.

As an alternative, the method for cutting a plate or panel made of porous construction material comprises the following steps:
supply of a plate or panel 1 of porous construction material,
movement of the plate or panel 1 in a direction X by movement means 3, 4 which comprise at least one conveyor,
cutting of the plate or panel by a wire 2 able to pass in a direction Y perpendicular to the direction X of travel of the plate or panel 1.

During cutting, the plate or panel 1 is moved by virtue of the conveyor 3, 4. It may be held by virtue of the suction holding system 5, 6, 7. The wire 2 may be able to move in a direction perpendicular both to the direction X of travel of the plate or panel 1 and to the direction Y in which the wire passes.

The method of cutting may be performed on-line, at the end of the production line that produces the plate or panel 1. In such a case, the speed of travel of the plate or panel 1 is at least 1 or 2 m/min, preferably at least 15 m/min, or even at least 30 m/min, it being possible for cutting to be performed in the thickness or on the edges.

The invention also relates to the mat or panel, for example made of mineral wool, cut by the cutting device according to the invention, according to the method of the invention, this mat or panel comprising, on at least one of its main faces or one of its edges, an excellent-quality cut, smooth to within a few tenths of a millimeter. What is meant by that is that the surface resulting from the cut exhibits a deviation between the most prominent point on this surface and the most recessed point on this surface that measures at most a few tenths of a millimeter, notably 2 tenths of a millimeter. This feature is obtained as a result of the diamond-gritted aspect of the wire.

The method according to the invention also guarantees that a high level of dimensional precision will be achieved for the panel, two mutually parallel opposite edges of which will have a parallelism defect not exceeding 2 tenths of a millimeter.

1. A method for cutting a starting mat, panel or plate of mineral wool or porous construction material into several mats, panels or plates, comprising:
supplying a starting mat, panel or plate of mineral wool or porous construction material, the starting mat, panel or plate having a front edge,
cutting the starting mat, panel or plate into two in its thickness by a wire, by moving the mat, panel or plate in a direction (X) using movement means that move the mat, panel or plate and comprise at least one conveyor, the wire being able to pass in a direction (Y) perpendicular to the direction (X) of travel of the mat, panel or plate, so as to form two first mats, panels or plates,
cutting the rear edge of the two first mats, panels or plates and the front edge of two second mats, panels or plates by moving the wire in at least a direction (Z) perpendicular both to the direction (X) of travel of the mat, panel or plate plate and to the direction (Y) in which the wire passes,
cutting the mat, panel or plate into two in its thickness using the wire, by moving the mat, panel or plate in the direction (X) of travel of the mat, panel or plate so as to form the two second mats, panels or plates, and
repeating the cutting front/rear edges and the cutting in the thickness in order to form two third and fourth mats, panels or plates.

2. The method of cutting as claimed in claim 1, further comprising cutting a rabbet in the front edge of the starting mat, panel or plate, a rabbet in the rear edge of the two first mats, panels or plates, and a rabbet in the front edge of the two second mats, panels or plates, to form rabbets in the rear and front edge of, respectively, the two second and third mats, panels or plates and the two third and fourth mats, panels or plates, by moving the wire in the direction (Z) and the mat, panel or plate in the direction (X) so as to make a cut in two mutually perpendicular directions.

3. The method of cutting as claimed in claim 2, further comprising a step of rotating each first and second mat, panel or plate through 90°, then cutting each first and second mat, panel or plate transversely in the direction of the initial length so as to cut rabbets on the two remaining edges.

4. The method of cutting as claimed in claim 1, in which the wire that performs the cutting has a diameter of between 400 μm and 700 μm.

5. The method of cutting as claimed in claim 4, in which the wire is diamond-gritted and comprises abrasive particles at its surface.

6. The method of cutting as claimed in claim 1, in which the wire passes at a linear speed of between 10 m/s and 20 m/s.

7. The method of cutting as claimed in claim 1, in which tension in the wire is set to a value of between 150 N and 500 N.

8. The method of cutting as claimed in claim 1, in which the mat, panel or plate moves at a speed of between 500 mm/s and 2 m/s for cutting in the thickness, and between 10 mm/s and 250 mm/s for cutting on the edges.

9. The method of cutting as claimed in claim 1, further comprising taking hold of the mat, panel or plate via holding means that comprise a vacuum holding system designed to move simultaneously with and in the same direction (X) as the movement means that move the mat, panel or plate.

10. The method of cutting as claimed in claim 1, in which the diameter of the wire is between 300 μm and 2 mm.

11. The method of cutting as claimed in claim 2, in which the wire is moved in the direction (Z) and the mat, panel or plate is moved in the direction (X) simultaneously so as to make the cut in two mutually perpendicular directions.

12. The method of cutting as claimed in claim 5, in which the abrasive particles of the wire include zirconium oxide.

13. The method of cutting as claimed in claim 5, in which the abrasive particles are of a size comprised between 30 and 80 μm.
